(19) United States
(12) Patent Application Publication
(10) Pub. No.: US 2018/0025551 A1
(43) Pub. Date: Jan. 25, 2018

(54) VEHICLE TOLL USAGE TRACKING SYSTEM AND METHOD

(71) Applicant: Highway Toll Administraton, LLC, Roslyn Heights, NY (US)

(72) Inventor: David Centner, Roslyn Heights, NY (US)

(73) Assignee: Highway Toll Administration, LLC, Roslyn Heights, NY (US)

(21) Appl. No.: 15/656,744

(22) Filed: Jul. 21, 2017

Related U.S. Application Data
(60) Provisional application No. 62/365,135, filed on Jul. 21, 2016.

(51) Int. Cl. G07B 15/06; G06Q 20/32; G06Q 40/00; G06K 7/10

(52) U.S. Cl. CPC G07B 15/063; G06K 7/10297; G06Q 20/3278; G06Q 40/12; G06F 17/30303

(57) ABSTRACT

A system and method for acquiring and communicating toll data including a server having a processing device and memory device operably connected to a toll database including toll related data related to toll usage. The server retrieving toll related data from the toll database at predetermined time intervals. The toll related data is acquired by a toll interrogation device from a toll identification device disposed on, and unique to, a particular vehicle passing though a tolling station. The processing device matching the retrieved toll data to a toll user responsible for the toll usage. The server electronically transmitting the matched toll information to the toll user.

This application claims the benefit of priority to U.S. Provisional Patent Application Ser. No. 62/365,135 filed on Jul. 21, 2016, the content of which is incorporated by reference herein in its entirety.

### FIELD OF THE INVENTION

A system for tracking vehicles through a road toll and matching vehicle information to toll usage information incurred during a specified time interval.

### BACKGROUND

The use of electronic toll collection systems is becoming evermore popular as a way of managing traffic volume through toll collection points. Such systems typically include a reader at the toll station which interrogates a wireless payment device located on a vehicle. The payment device may be a transponder, such as an RFID (radio frequency identification device) or optical camera. Upon interrogation by a reader, the transponder emits a radio frequency signal that includes information corresponding to an account code unique to the transponder and/or vehicle. Therefore, the user can be properly charged for going through the toll. Such transponders are marketed by Mark IV Transportation Technologies Group and TransCore. The transponders operate with toll collection systems such as E-ZPASS® and SunPass®. In order to function properly, the transponder must be in radio frequency (“RF”) communication with the interrogator. If this communication is interrupted, the transponder will not be acknowledged. Therefore, the transponder is typically located on the windshield or other part of the vehicle where it is unobstructed by the metal body of the vehicle.

Organizations across the world are moving towards electronic submission of expenses for reimbursements. Expense management systems such as Concur® and Certify® allow for easy submission of all travel expenses. Toll-related expenses are not captured in such submissions; therefore, they must be manually gathered and included. In most cases, employees simply shoulder the cost, as they just do not possess the time to be bothered with these tedious tasks.

Individuals can manually pay the tolls and then submit the receipts after the fact, however, this is a very time consuming process. Most rental and private vehicles are now equipped with electronic toll transponders. In such instances, the individual will be charged and they must manually submit that charge for reimbursement. However, there is currently no simple method to submit reimbursements for toll expenses. Additionally, for rental car customers, the toll charges are typically billed many weeks later. This causes issues for the business traveler, as expense reimbursement cycles are much shorter.

Accordingly, it would be desirable to provide a system for tracking vehicles through a toll station and gathering and organizing toll information incurred during a specified time interval, and rendering the tallied cost information to the customer for automated expense submission.

### SUMMARY

The present disclosure provides a system and method for acquiring and communicating toll data including a server having a processing device and memory device operably connected to a toll database including toll related data related to toll usage. The server retrieving toll related data from the toll database at predetermined time intervals. The toll related data is acquired by a toll interrogation device from a toll identification device disposed on, and unique to, a particular vehicle passing though a tolling station. The processing device matching the retrieved toll data to a toll user responsible for the toll usage. The server electronically transmitting the matched toll information to the toll user.

The present disclosure also provides a system for acquiring and communicating toll data including a toll management system having a server, the server including a memory device having instructions stored thereon, and a processing device operably coupled to the memory device. The processing device, upon execution of the instructions, performs steps including:

receiving registration information from a user wherein a vehicle identification device disposed on a vehicle is linked to a user;

receiving toll data including toll activity from the toll database;

matching the received toll data to a toll user responsible for the toll usage;

transmitting the matched toll data to a software application on a user's mobile device; and

receiving an instruction from the user's mobile device to transmit the toll data to a third party, and transmitting the toll data responsive to the instruction.

The present disclosure further provides method for acquiring and communicating toll data including:

providing an input for setting up a user account on a mobile computing device;

inputting identifying information;

wirelessly communicating with a server, the server including a processing device and being in operative communication with a toll database; the server periodically communicating with the toll database to obtain toll data at predetermined times;

receiving from the server toll data specific to the user account;

displaying the toll data on a display;

providing a selection for the user to initiate transmittal of the toll charges to a third party reimbursement server; and

the server transmitting the user information and the toll charges to the third party expense management system.

The present disclosure still further provides method for acquiring and communicating toll data including:

receiving registration information from a user wherein a vehicle identification device disposed on a vehicle is linked to a user;

receiving toll data including toll activity from the toll database;

matching the received toll data to a toll user responsible for the toll usage;

transmitting the matched toll data to a mobile device; and

receiving an instruction from the mobile device to transmit the toll data to a third party responsive to the instruction, and transmitting the toll data responsive to the instruction.

The present disclosure yet still further provides a non-transitory computer-readable storage medium including instructions that, when executed by a processing device, cause the processing device to process toll transactions by performing a computer process including:

receiving registration information from a user wherein a vehicle identification device is linked to a user;

receiving toll data from a toll database;

matching the received toll data to a toll user responsible for the toll usage;

transmitting the matched toll data to a mobile device;

receiving an instruction from the mobile device to transmit the toll data to a third party; and

transmitting the toll data responsive to the instruction.

### BRIEF DESCRIPTION OF THE DRAWINGS

FIG. 1 is a flow diagram of the overall toll management system.

FIG. 2 is a schematic representation of the toll management system.

FIG. 3 is a schematic presentation of a toll location.

FIG. 4 is a schematic representation of a file-based retrieval/integration system.

FIG. 5 is a schematic representation of a web-services retrieval/integration system

FIG. 6 is a flow diagram of a toll matching algorithm.

FIGS. 7A and 7B is a flow diagram of the toll management system for a rental car user.

FIGS. 8A and 8B is a flow diagram of the toll management system for a private car user.

FIG. 9 is a schematic illustration of a logical architecture of the toll management system.

FIG. 10 is a schematic illustration of a mobile logical system architecture of the toll management system.

FIG. 11 is a schematic illustration of a mobile solution ecosystem.

FIG. 12 is a schematic illustration of an iOS mobile architecture.

FIG. 13 is a schematic illustration of an Android mobile architecture.

FIG. 14 is a block diagram showing a portion of an exemplary device in the form of a computing system that performs methods according to one or more embodiments.

FIGS. 15-28 include screen shots of a toll management application software.

### DETAILED DESCRIPTION

The present disclosure provides a system of tracking a vehicle as it travels through a toll system. The resulting toll activity may be organized to assist users. The system also provides a user, such as business travelers, with a system to register toll transponders and/or license plates both for rental and private vehicles. The user may then summon a full report on their tolling activities. The toll management system may then generate journey reports, receipts, and send alerts/notifications whenever toll charges are incurred. The toll management system streamlines tracking vehicle's use of a tolling system and the submittal of toll expenses for purposes such as reimbursement.

The toll management system may have deep integration capabilities with expense management systems such as Concur®, Amex®, Certify®, etc., allowing the export of such expenses directly into a business traveler's reimbursement system. In this way, toll expenses, which are difficult to manually keep track of and tally, may be automatically submitted for reimbursement.

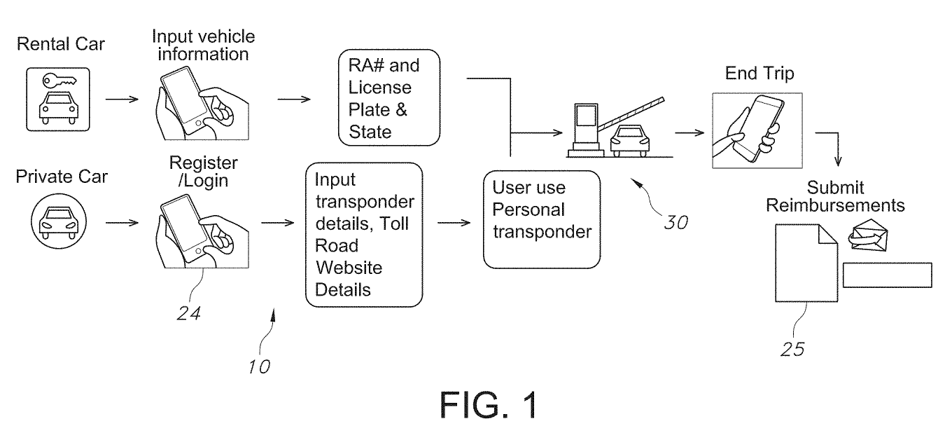

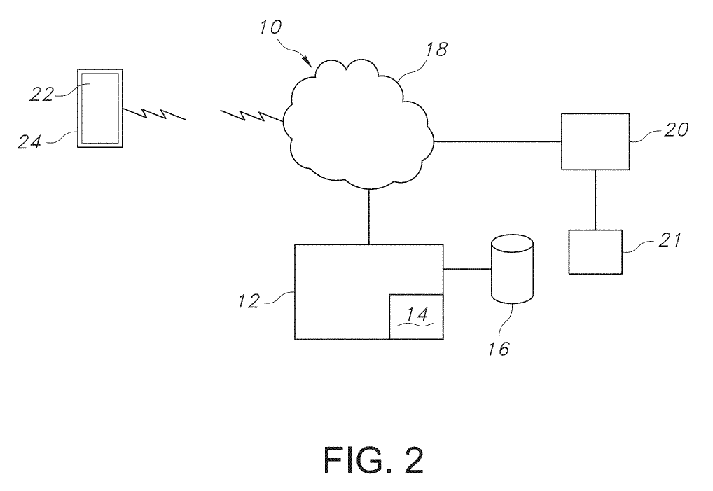

With reference to FIGS. 1 and 2, the toll management system 10 may permit a user of a private or rental vehicle to input or to login information to a mobile computing device. Details of a user and an associated vehicle are included on a server in communication with a toll station 30. The vehicle is tracked through the toll station 30 and toll usage information is processes and transmitted to a user's computing device 24. The computing device 24 may then interface with an expense management system and/or software 25.

The system 10 may include a server 12 including one or more processing devices 14 operably connected to database memory device 16. The server 12 may also be operably connected to a communications network 18, such as the World Wide Web, in order to permit the server to communicate with third-party servers 20. The third parties may include toll authorities and toll reimbursement management systems. The toll authority, also referred to herein as toll road, is the entity to which operates the toll stations or toll collection points 30 and to which the toll charges are paid, e.g., the Port Authority of New York, the Metropolitan Transportation Authority, or the New York Throughway Authority. The toll authority may maintain a toll charges database 21 which contains toll usage information for each vehicle that passes through its toll stations. The toll management system server may 12 also be connected to servers of vehicle rental agencies. When a user rents a vehicle, the toll charges incurred by the user of the rental vehicle may be tabulated and reported to aid in reimbursement, as will be further described below.

The system 10 may further include toll management application (“TMA”) software 22 running on a computing device 24 of a user. The computing device 24 may be in the form of mobile computing device such as a smartphone, tablet, laptop, or a PC or other computing device. The mobile device 24 may be operably connected to the toll management system server 12 via the TMA software including to permit the user to input and receive data from the server 12. The TMA software may include various screens presented to a user in order to allow them to enter registration and authorization information. The screens generated by the TMA software 22 will also display information as to incurred toll charges

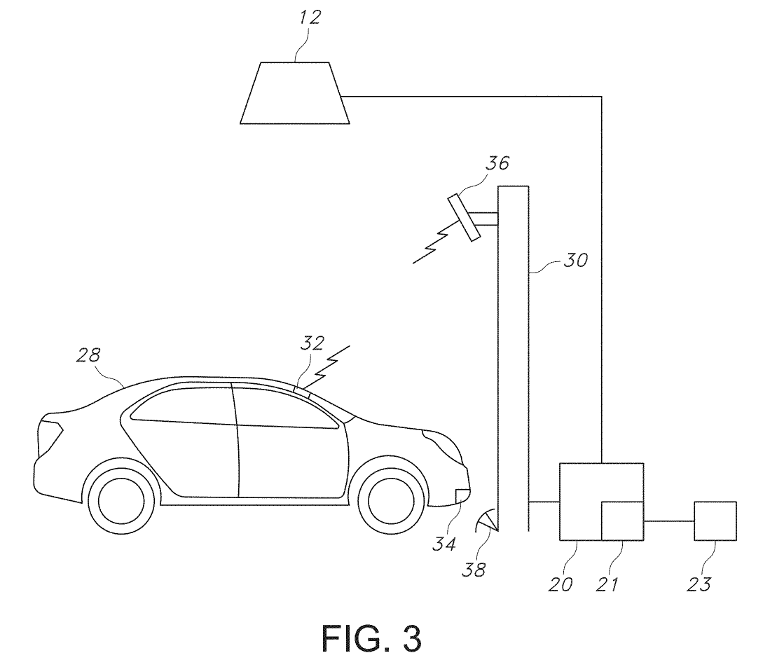

With reference to FIG. 3, when a user in a vehicle 28 drives through a toll station 30, the vehicle is interrogated. The vehicle may have a transponder 32 and/or license plate 34 or other unique identifier that is interrogated/scanned by an interrogation device such as a scanner 36 and/or optical camera 38. The unique identifier information is collected by the toll authority server 20 and stored in a toll authority database 21. This permits the toll usage amount to be charged to the correct user. The toll authority may also provide this toll information over a network to other tolling authorities that participate in an interoperability hub such as E-ZPASS®. The toll management system server 12 is integrated with the toll authority database 21 and/or transponder provider database 23. The toll management system server 12 may initiate communication with the databases 21, 23 and pull toll data therefrom so that toll charges and the corresponding identification information may be obtained. Alternatively, the toll data information may be pushed from the toll authority database 21 and/or transponder provider database 23 via the server to the toll management system server 12 in real-time as the toll charges are incurred, or at predetermined intervals. The server 12 generates a signal that communicates with the TMA which advises the user that a toll charge has been issued. The TMA may be configured to itemize toll receipts for expense reimbursement. For example, the application may provide users of private car with a list of toll charges they have incurred, which can then be submitted to the user's employer or converted into an itemized receipt. The provided information may include such details as toll plaza, toll amount, date, and time.

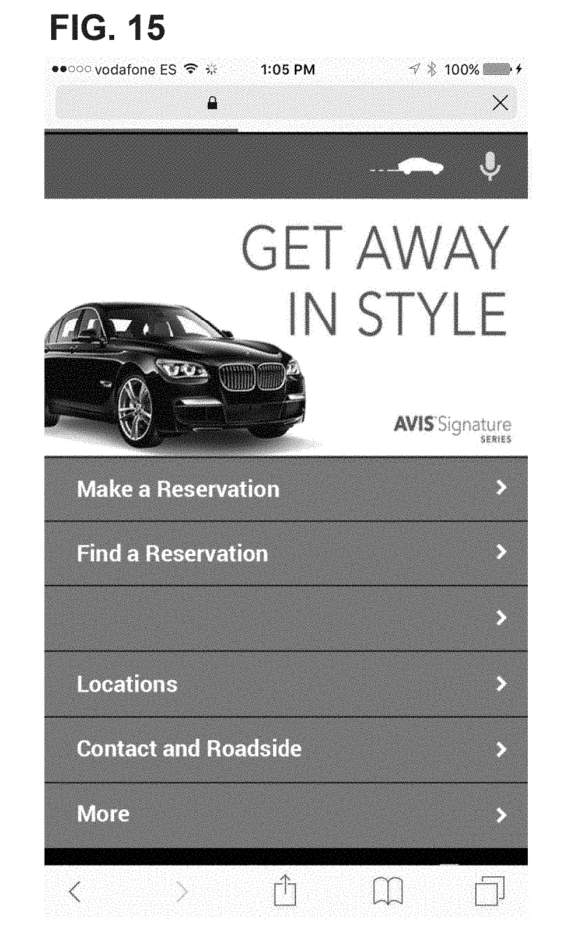

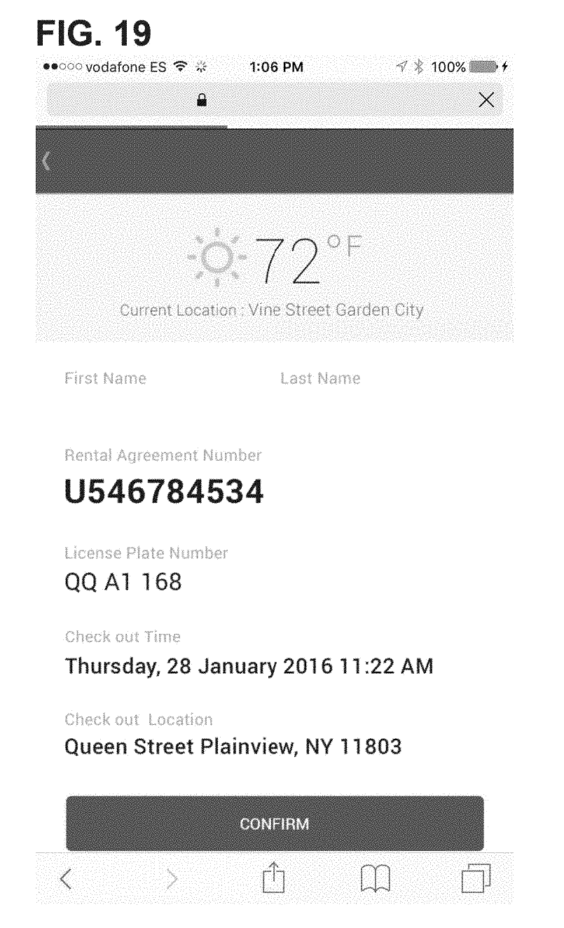

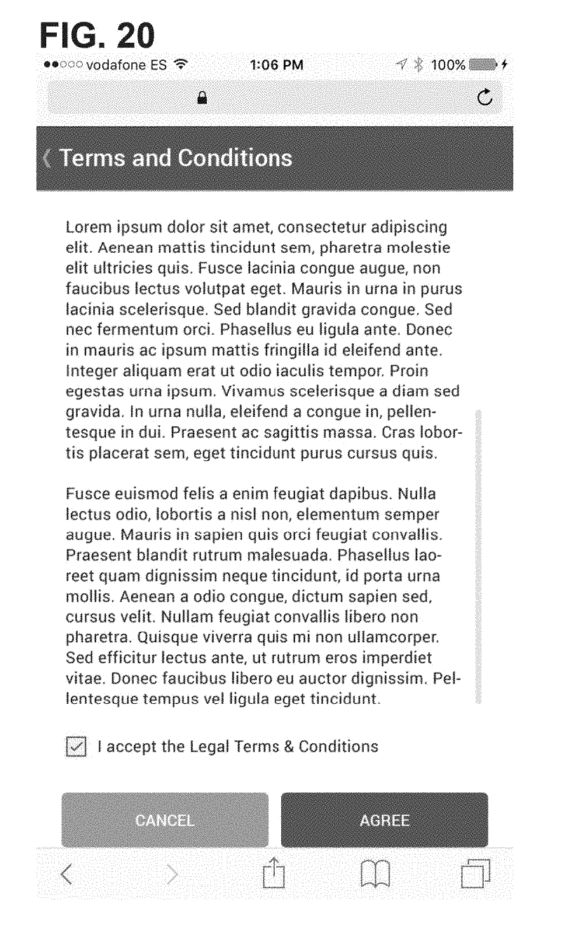

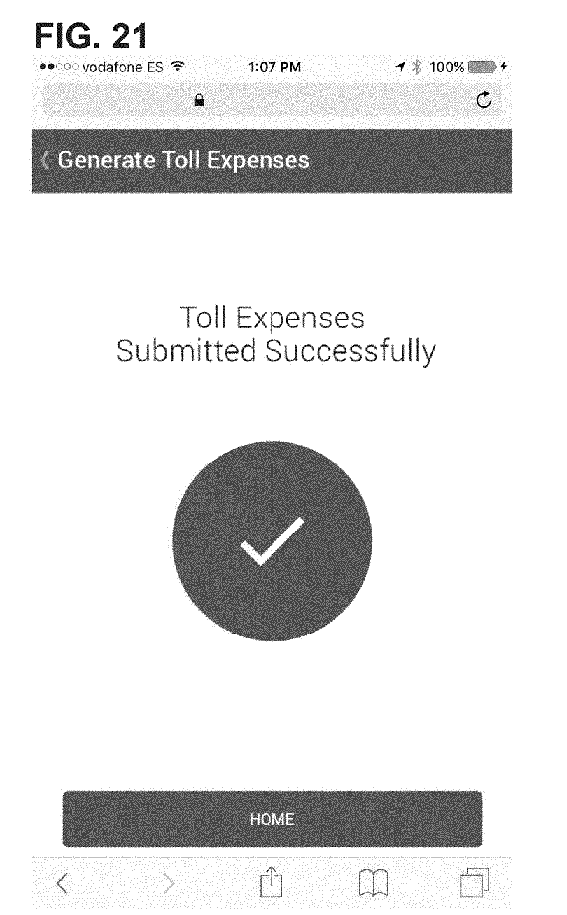

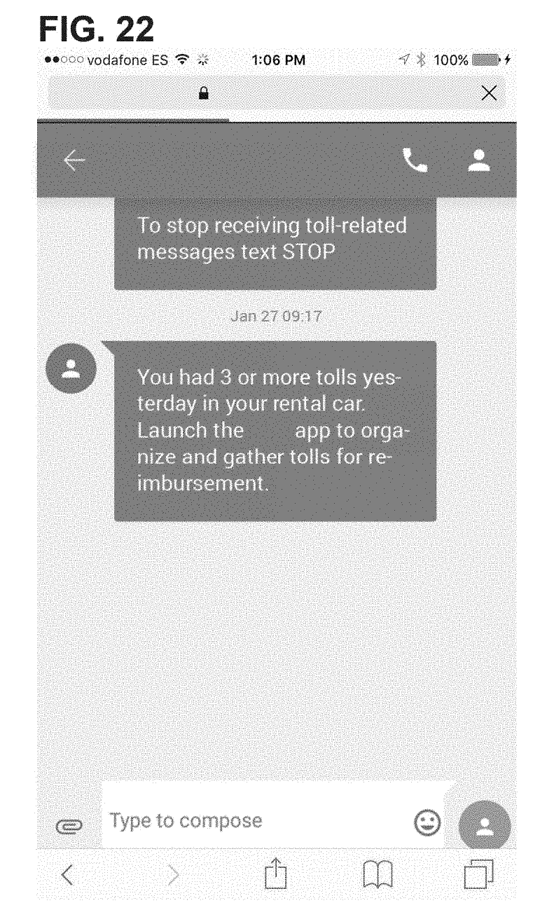

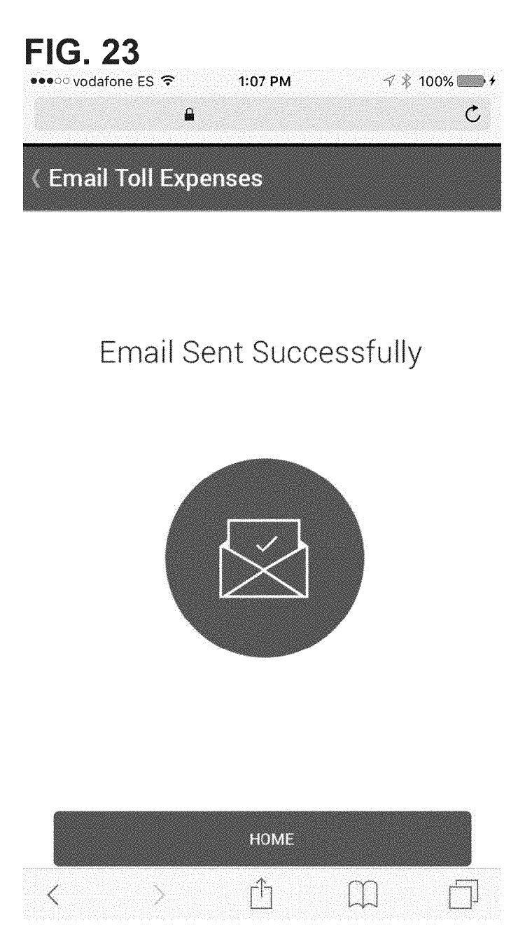

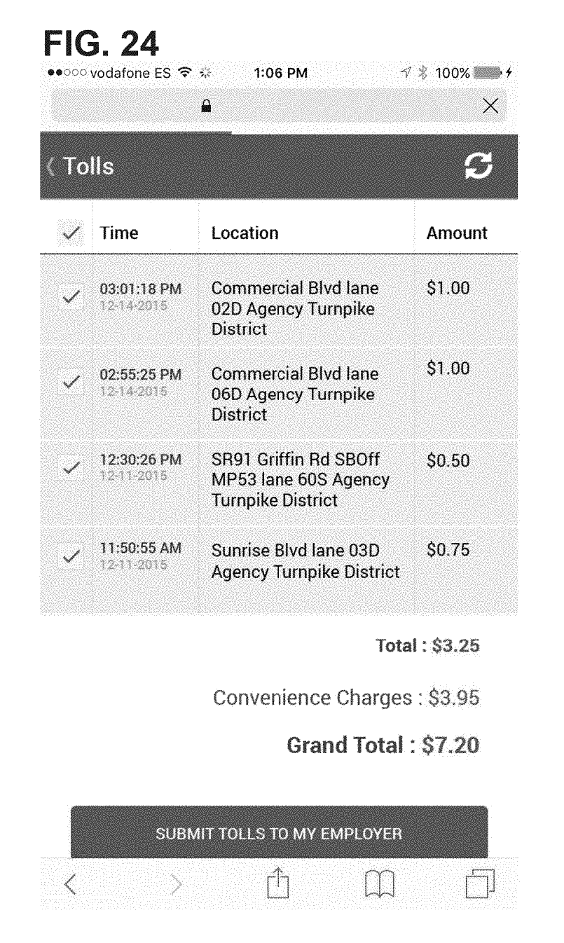

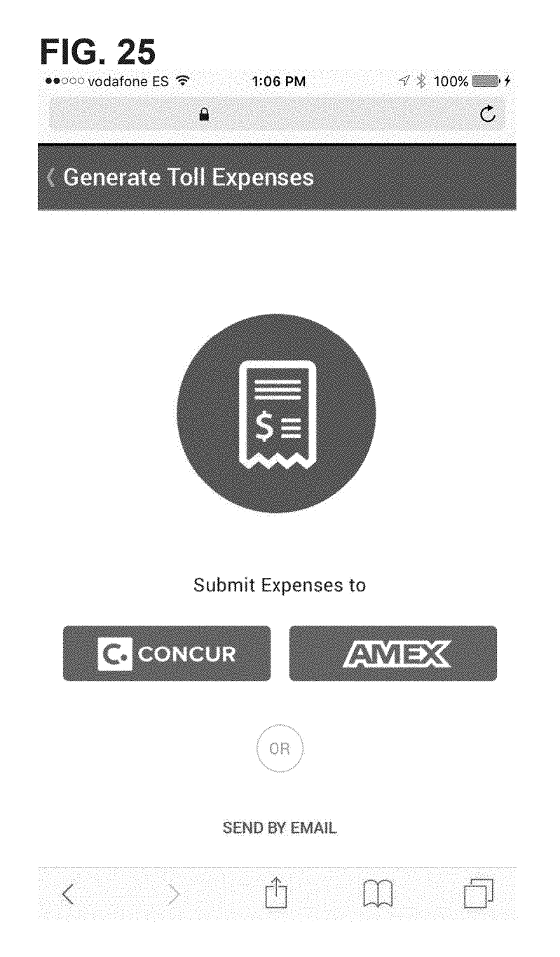

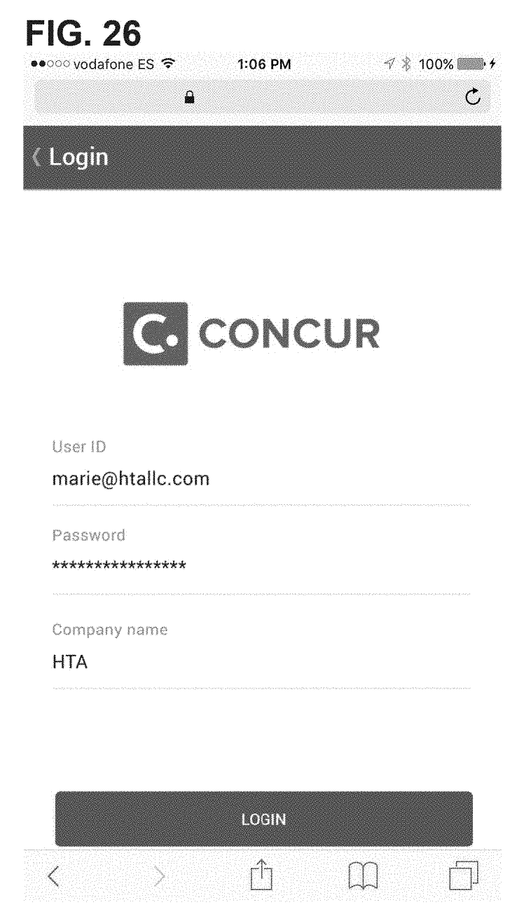

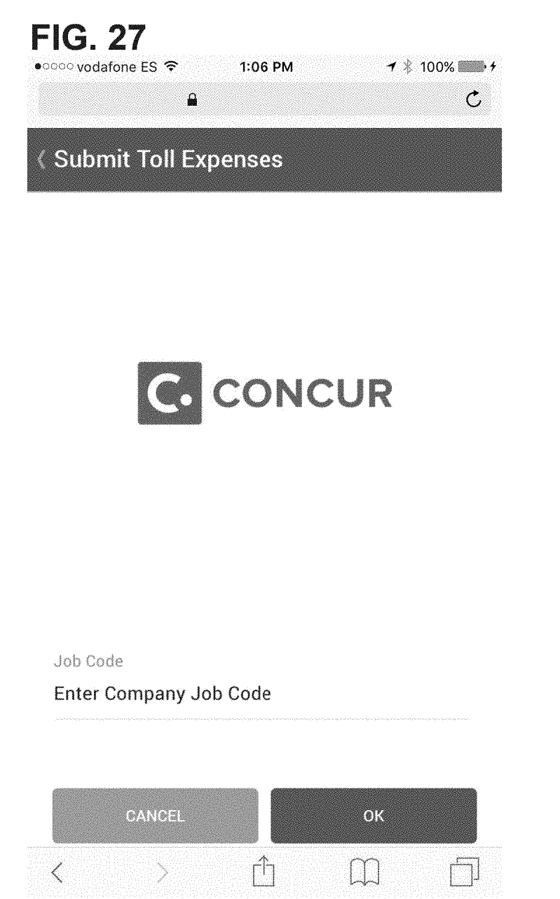

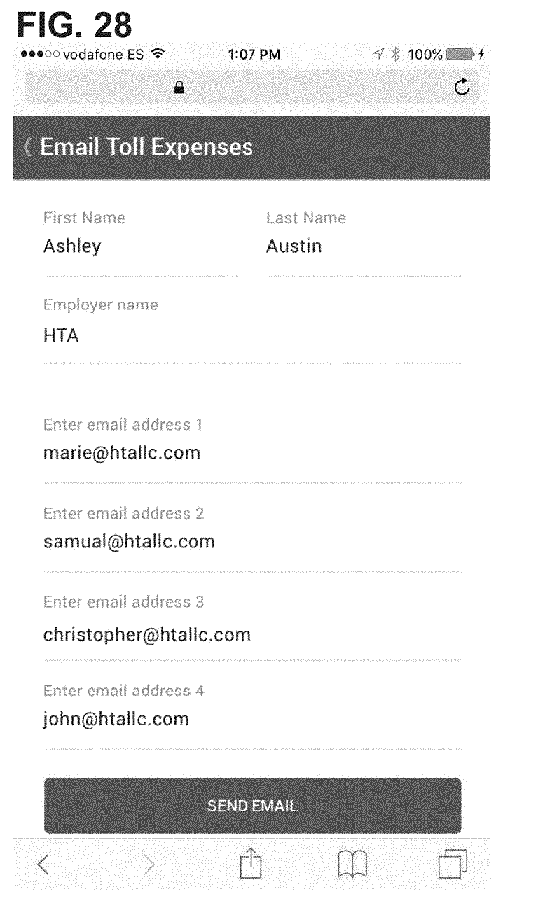

Users may load the TMA software 22 onto their mobile device 24. The TMA software causes the mobile device to communicate with the main system server 12 over a wireless cellular network. The TMA may present a series of screens to the user to permit the various functionalities to be utilized, as shown in FIGS. 15 to 28. The TMA software may also provide a user with the ability to view toll receipts. The application may provide a notification in real time to the user when they have incurred a toll charge. For example, when a user drives through a toll, the charge could be pushed to the server 12 which causes a communication to be sent to the user's mobile device 24 indicating that a toll change has been incurred. All current and previous toll receipts may be viewed. The user may also be able to view any outstanding balances that are due as a result of toll usage. The application may further provide rental check-in services. A rental car user may use geo-fence data to provide enhanced check-in capabilities to the rental agencies. The geo-fence uses the global positioning (GPS) or radio frequency identification (RFID) to define a geographic boundary. When the user having the mobile device 24 enters the boundary, an alert or message can be sent to the user's mobile device related to check in.

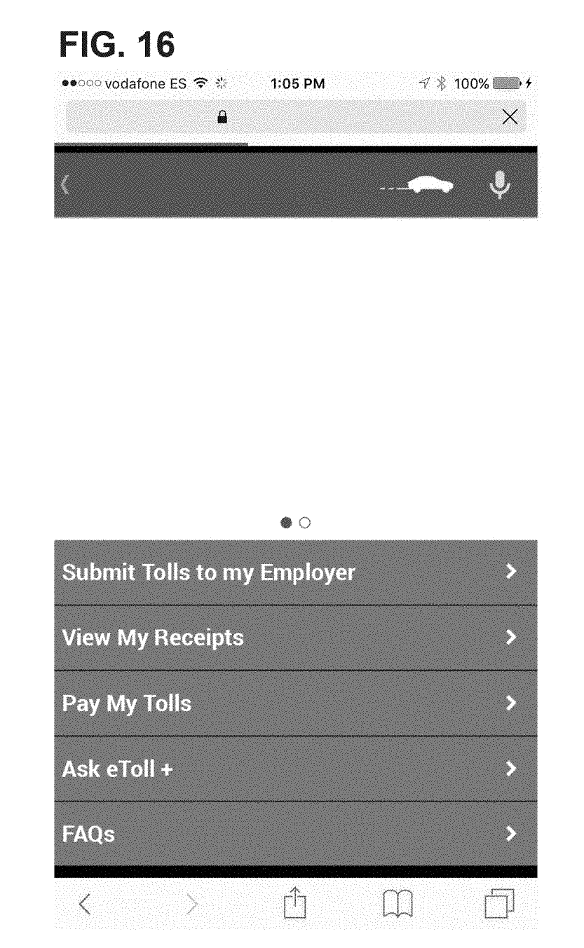

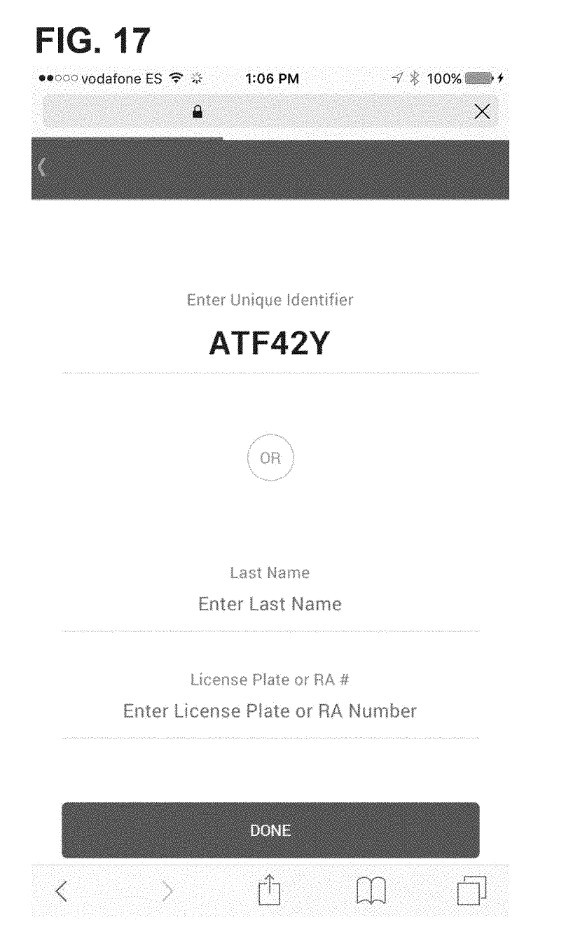

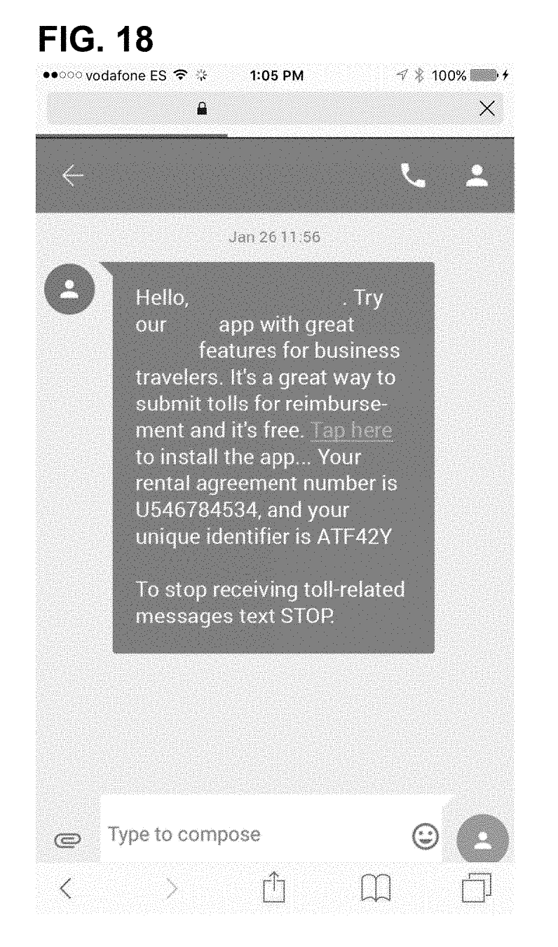

The TMA may include functionality which permits a user to not only view the toll charges and submit them for reimbursement, but also to pay them. A car renter may use a payment gateway integration feature to pay directly through the mobile software application. The TMA may include car rental features to permit a user to reserve a rental vehicle as shown in FIG. 15. The TMA may also permit a user to submit tolls to their employer, view toll receipts and to pay tolls as shown in FIG. 16. The use may be given a unique identifier (FIGS. 17-18) to permit a user to take actions using the TMA.

The TMA may provide an input selection screen wherein the user can identify themselves as either a rental vehicle user or a private car user. The TMA would provide user authentication. When the vehicle is a rental car application, the rental vehicle company may have its own mobile application that works with the TMA. The rental vehicle application will call the toll management system server web services for user actions. The toll management server will then authenticate the web services and return the appropriate response.

For private car users, authentication may be achieved by the user creating a profile on the TMA software. The user may also be prompted to provide their vehicle identification information such as current license plate and toll transponder identification number. The user may also provide their authentication details to allow access to a toll road portal, such as an EZ-Pass® account, for automatic login. If the toll road portal challenges with a challenge-response test, such as a Captcha®, then the TMA will present an interface for the user to enter the Captcha® or other information to satisfy the challenge. In an alternative embodiment, the TMA may store third party application credentials, such as Concur®, Amex®, E-ZPass®, etc, for automatic login purposes. The user may then be presented with an agreement which would provide authorization for the toll management server to retrieve toll details for a toll transponder on the user's behalf. This would permit toll usage information to be transmitted from the toll authority to the toll payment entity.

User authentication can be employed with third party expense management systems such as Concur®, Amex®, etc. A user may be prompted for the third party credentials through the TMA. The toll management server verifies the credentials using partner web services. Credentials may be stored in the user's account or locally on their mobile device for reuse later. Therefore, verification would not need to be repeated. With the third party verified, a user may have toll payment information passed on to the third party so that expense reports can be efficiently processed.

The toll management system 10 may be integrated with the toll authorities and the provider of toll collection transponders in order to obtain relevant toll charges. For rental car applications, the toll management system will be integrated with toll roads databases to periodically collect toll data for registered rental vehicles. For private vehicles, user account credentials will be utilized in real-time or near real-time to capture toll usage data. The system may include a real-time interface to capture toll usage data for private vehicle and rental vehicle via direct web service integration with toll roads and/or transponder providers.

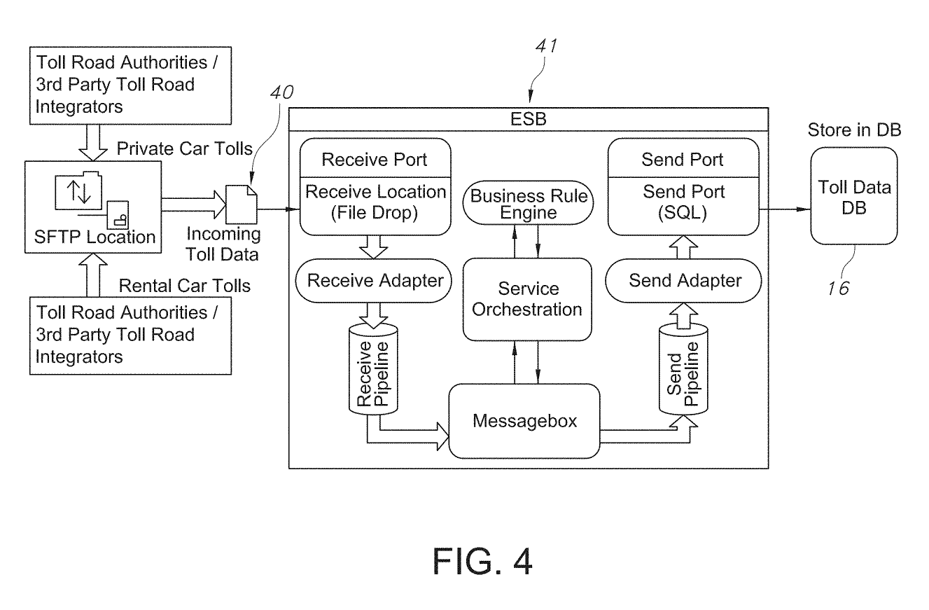

In order to obtain the necessary toll data to determine if a toll charge has been incurred, the toll management system 10 allows for toll data aggregation. With reference to FIG. 4, one method of data aggregation includes file-based retrieval/integration. The toll management system can obtain a formatted file from toll authorities or a transponder provider at a predetermined frequency such as 24 times a day. The frequency of this file retrieval may be modified depending on the toll roads. The more frequent the toll usage data is received, the faster the toll data can be delivered to the toll user. In the event such data files are not available to be programmatically retrieved, they can be manually downloaded using a PL/SQL based ETL system or Enterprise Service. A data bus can be utilized for this process. For example, as shown in FIG. 4, toll data 40 including plate numbers, toll amount and location generated by toll authorizes and/or third party toll integrators, is collected and transmitted to a Enterprise Service Bus (ESB) 41 such as BizTalk®. The ESB permits different software systems to communicate with each other. The ESB 41 converts the data into a form more readily usable and the converted data is then transmitted to the toll data database 21.

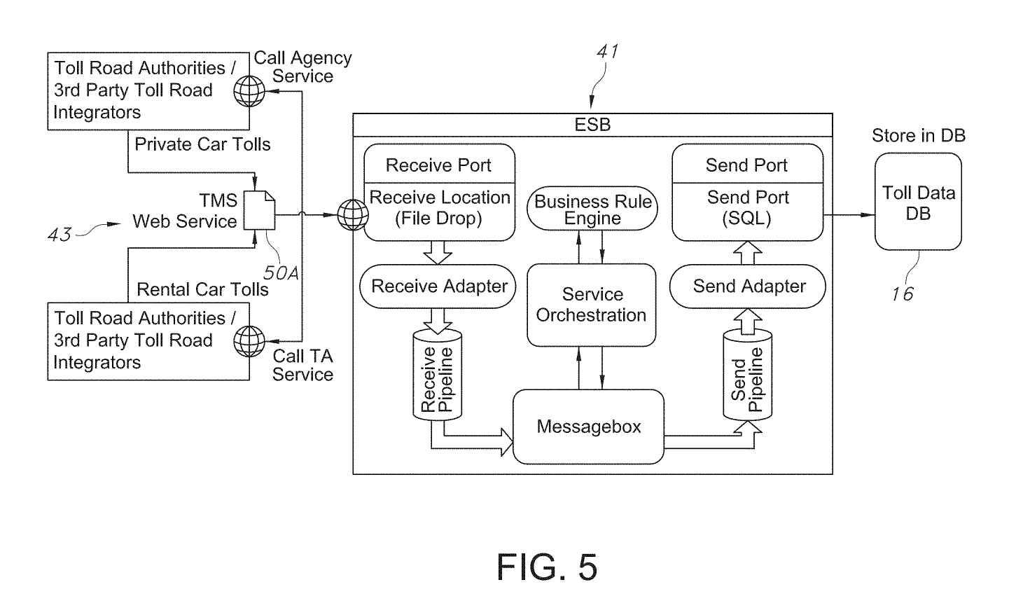

With reference to FIG. 5, a second method of data integration may be a web services retrieval/integration. The toll authority can use the toll management system service-oriented architecture (“SOA”) service 43 to send toll data directly to the platform, or the toll authority can directly host web services, where the toll management system 10 would invoke them. An ESB 41 such as BizTalk® may be employed for service orchestration and toll data validation. In this embodiment, the ESB Scheduler Adapter may poll the Toll Road Authorities or Transponder Agency and Transponder services periodically. For example, a service may call for the data at certain intervals, for example every two minutes. The data is processed by the ESB and transmitted to a toll data database 16.

A third method of data integration may be a toll data web portal capture. The toll management system services 10 would possess methods such as automated scripts to log in to all toll authority management portals. Upon login, toll data may be selected and downloaded to the toll management system database 16.

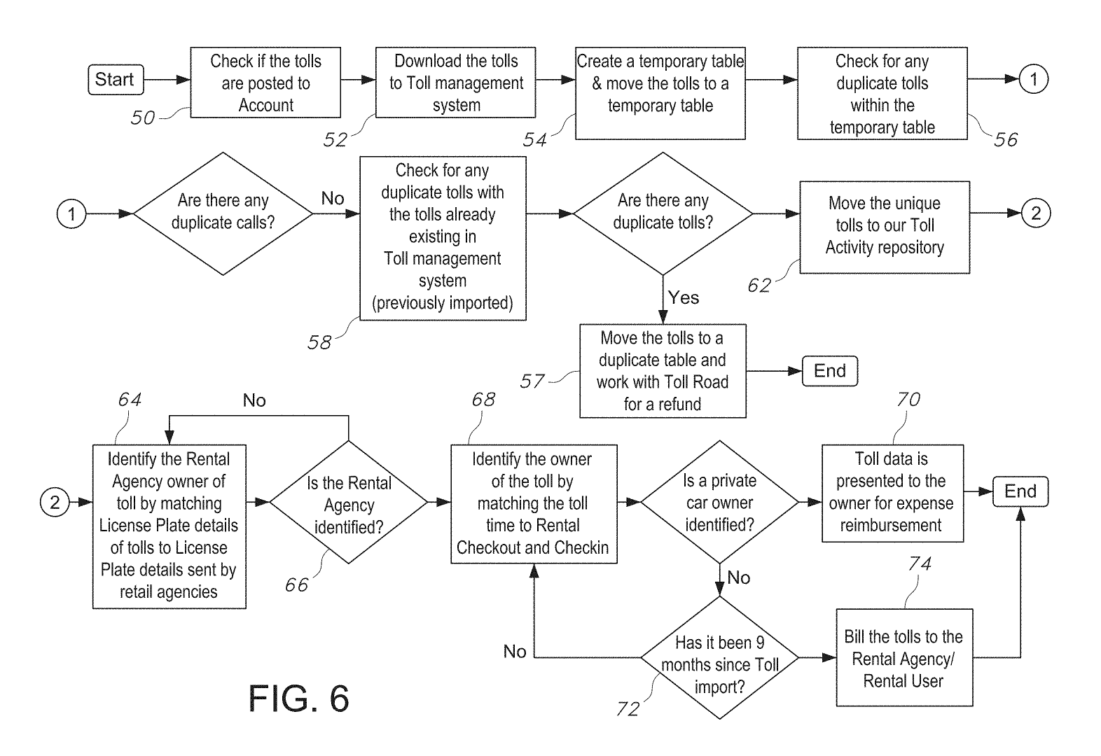

With reference to FIG. 6, once toll charges are imported into the toll management system database 16, a matching algorithm running on the toll management server would be initiated in order to match the toll charge with the user. The toll matching may begin by the server initiating a check to see if the tolls are posted to an account 50. If so, the toll information is downloaded to the toll management system database 52. A new temporary table is created and the toll information is moved to a temporary table 54. A check is initiated to determine if there are any duplicates in the temporary table 56. If there are none, a check is made for duplicate toll with the tolls already in the toll management server database 58. If duplicates are identified, the duplicate tolls are moved to a duplicate table and a process can be initiated with the toll road for a refund if necessary 57. Non-duplicates are moved to a toll activity repository 62. The rental agency owner of the toll charge is identified by matching the license plate details or a transponder ID of each toll charge to the license plate details sent by the rental agency 64. This step may be repeated until the rental agency is identified 66. The owner of the toll charge, i.e., the individual who rented the vehicle, is identified by matching the vehicle with the toll time in between the rental checkout and check in time 68. If a predetermined time period has expired, e.g., 9 months, and the owner of the toll charge has not been identified 72, then a bill for the tolls may be sent to the rental agency 74. If a private car owner is identified, the toll data is presented to the owner for expense reimbursement 70. If not, the prior identity step is repeated.

A sample pseudo-code for the matching algorithm is as follows:

```
Import Tolls from Toll Account(s)
Insert into Toll data into Temporary Table
Check For Duplicate Tolls in Temporary Table and database of Toll Management System
for following criteria:
  { Toll Entry Time,
    Toll Exit Time,
    Toll Entry Plaza,
    Toll Exit Plaza,
    License Plate State,
    License Plate Number,
      Toll Amount
}
Identify Duplicate Tolls & Insert into Duplicates Toll Table
Identify Unique Tolls & Insert into Toll Management System
Insert Fleet Information (Open/Closed Rental Agreement Number, License Plate
Number, Plate State) sent by Rental Agency into Toll Management System
If
{
License Plate State & License plate Number of the tolls from Toll Table matches with
License Plate State & License plate Number sent by Rental Agency
And
Toll Import Date less than ‘n’ number of days from Current Date
Then Find the Rental Contract associated to the toll and Bill Customer
Else
Bill Rental Agency
}
Else
Match Toll if License Plate is a Private Car User
Then push toll information to Private Car User
}
Keep Looking for New Toll Imports in Toll Table
End.
```

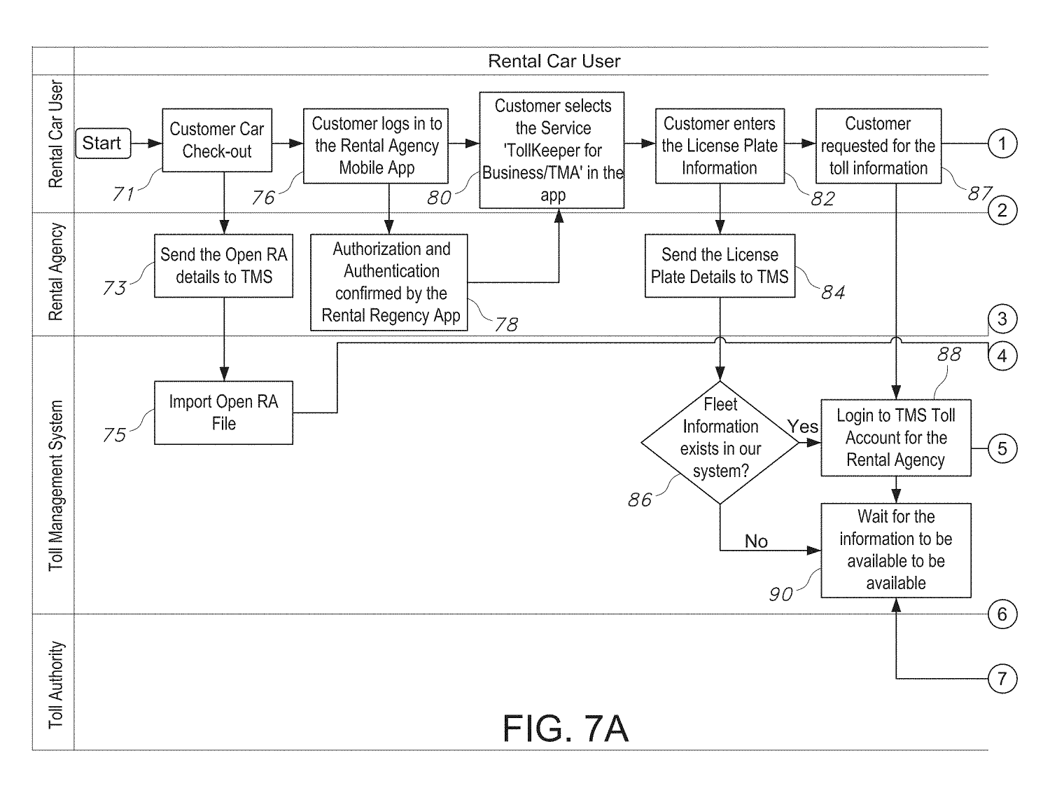

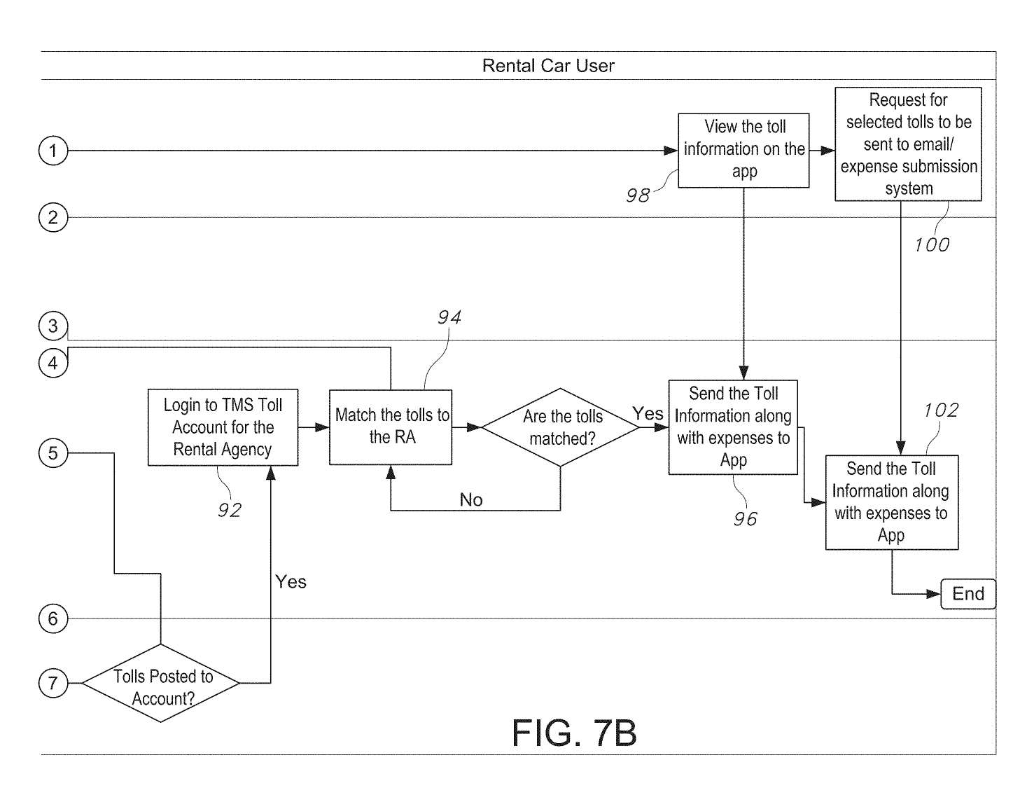

With reference to FIGS. 7A and 7B, in operation of the toll management system (“TMS”) rental car embodiment, the user/customer would check out the rental vehicle 71. The rental agency could then communicate with the toll management system 10 and provide details of the vehicle rental 73. The toll management server 12 may then import the rental agency details 75 and store it on its server. The user may then log into the rental agency's mobile software application 76. This may be done via the user's mobile device 24. In response to the user logging into the rental company's application, the server conducts an authorization process 78. If the authorization is confirmed, a message is sent to the user's device. The user may then be offered a selection of services. One of the services, e.g., Tollkeeper for Business, may be associated with the toll management system 80. This selection provides the users with the integrated TMA software functionalities.

Upon selecting the service, the user may receive a prompt to enter unique identifying information such as the license plate of the rented vehicle or a code sent via SMS 82. The user requests the toll information 87. The rental agency application is then authorized to forward the entered information to the toll management system server 84. The toll management system 10 determines if the plate or transponder number corresponds to a vehicle in a rental company fleet that has been registered with the toll payment system 86. If it does, the toll management system then logs into the account for the particular rental agency 88. If it has not, then the toll management system waits for further information to be made available 90.

When the user passes through a tolling station, such as a toll booth, the toll road scans the vehicle for a toll payment device, such as a RFID transponder or license plate. The toll collection agency will determine if the plate or tag is assigned to a registered owner. For example, if the car is a rental vehicle that has an RFID toll tag to permit payment of tolls, the tag will be registered with an owner. The owner may be the operator of the toll management system. When the vehicle passes through the toll collection area, the toll charge is recorded and saved. The toll management system server 12 may communicate with the toll authority database and retrieve and import therefrom the toll data along with the vehicle or tag information 92. The toll management system server 12 determines if the transmitted vehicle or tag information matches data imported from a rental agency 94. This step allows the toll management system to match the toll charge with the rented vehicle. If there is a match, in response to the user requesting toll information 97, the toll management system communicates with the user via the TMA software 96. This permits the user to view the toll information such as the toll collecting area and the toll amount charged 98.

In order to facilitate reimbursement of the toll expenses, the user may select a request that the toll information be communicated to an expense submission system 100. If the user makes this selection, the toll management system server will communicate with such a system 102. In this way the user can review and submit the toll fees for reimbursement in a timely and efficient manner.

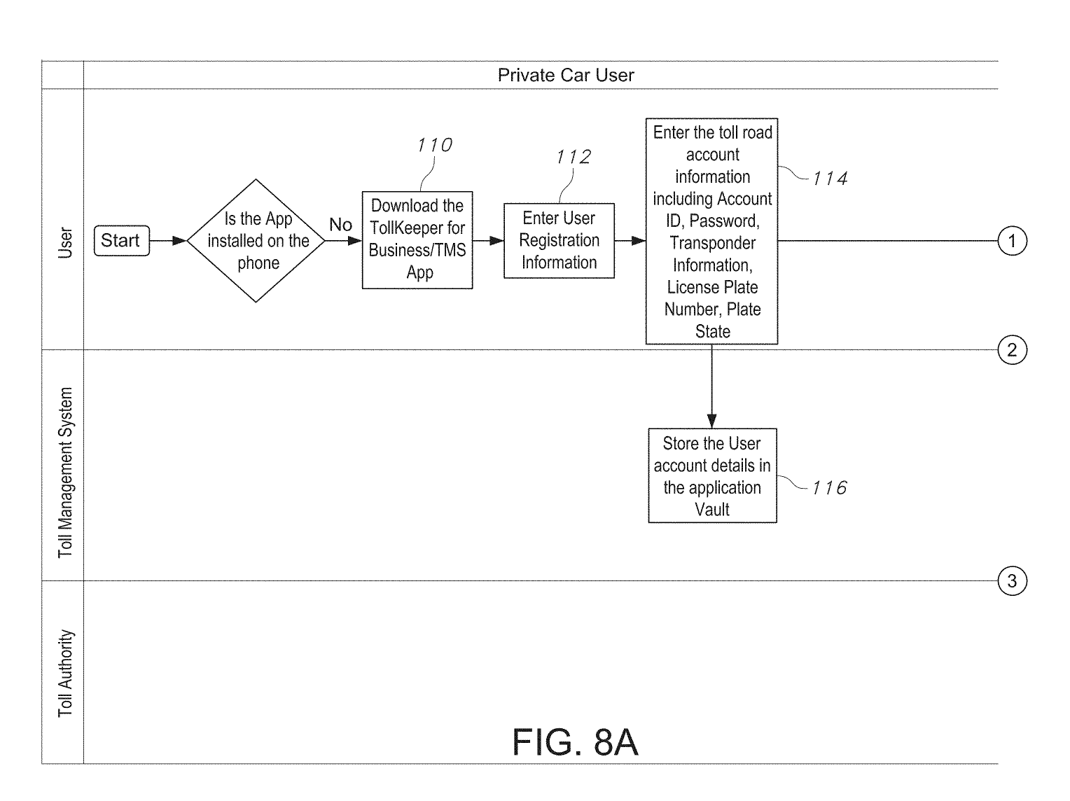

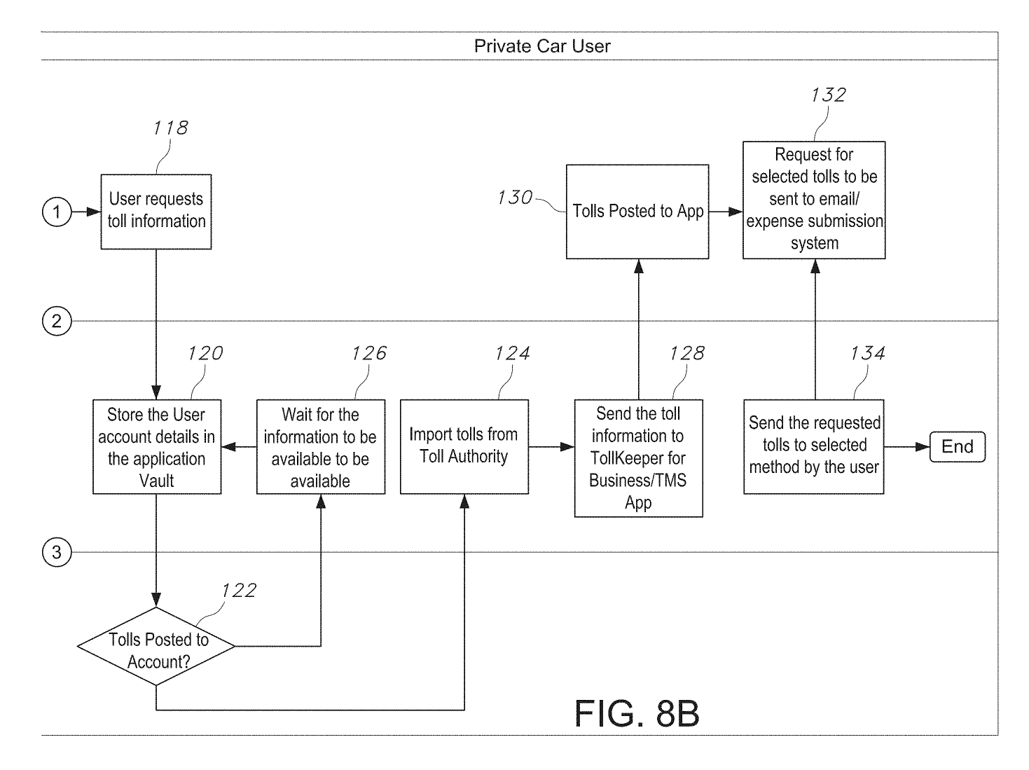

With reference to FIGS. 8A and 8B, the system of the present disclosure may include an embodiment for the case where a user is not renting a vehicle but is using their own vehicle. The user may install the TMA software on their mobile device 110. The user may then enter registration information such as name and address 112. The user may then enter toll road account information such as account ID, password information, license plate number and state 114. The entered information is transmitted by the software application to the toll management system which stores the information in the database 116.

When a user travels past toll collection stations, the toll road station 30 scans the vehicle transponder and/or license plate and logs use activity in a manner well known in the art. Periodically, the user may want to see the toll activity so it can be made part of an expense report for reimbursement purposes. The TMA software may include an input box from which the user may request to see the toll usage information 118. In response to the request, the toll management system may login to the user's account 120. The toll management systems server sends a communication to the toll authority database to determine toll usage of the user 122. If the toll information has been posted, the toll information is imported by the toll management system server 124. If the toll information has not yet been posted, a wait period is initiated 126. After the wait period expires, the toll management system may again communicate with the toll authority system. Once the information has posted, the information will be imported in the toll management system. The toll management system then transmits the toll information to the user via the TMA software 128. The user can review the toll charges on the mobile device 130. The user can take the information and use it to complete an expense report in order to seek reimbursement. Alternatively, the user can request that selected tolls be sent to an expense submission system 132. The application may permit the user to select specific tolls. In this way, only tolls for which the user seeks reimbursement may be submitted. The toll management system server 12, upon receipt of the request, may then send the selected toll expenses to the expense system 134. In this way, the mobile application permits a user to timely and efficiently seek reimbursements for toll expenses.

It is also contemplated that the user may be alerted to a toll charge via a SMS message and or email. The user may provide such information upon registration via the TMA. In this way, the user may receive the information even if the TMA is not running.

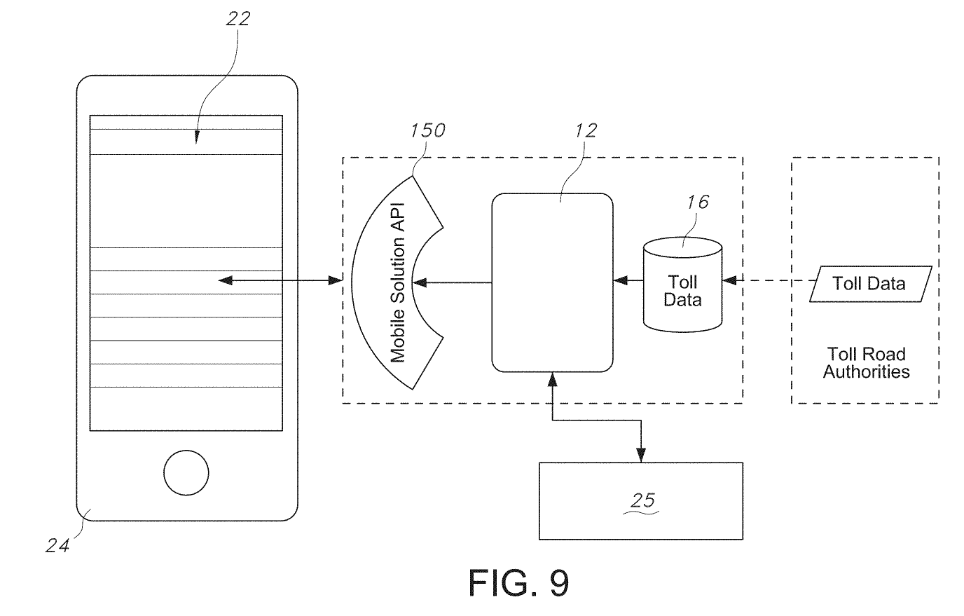

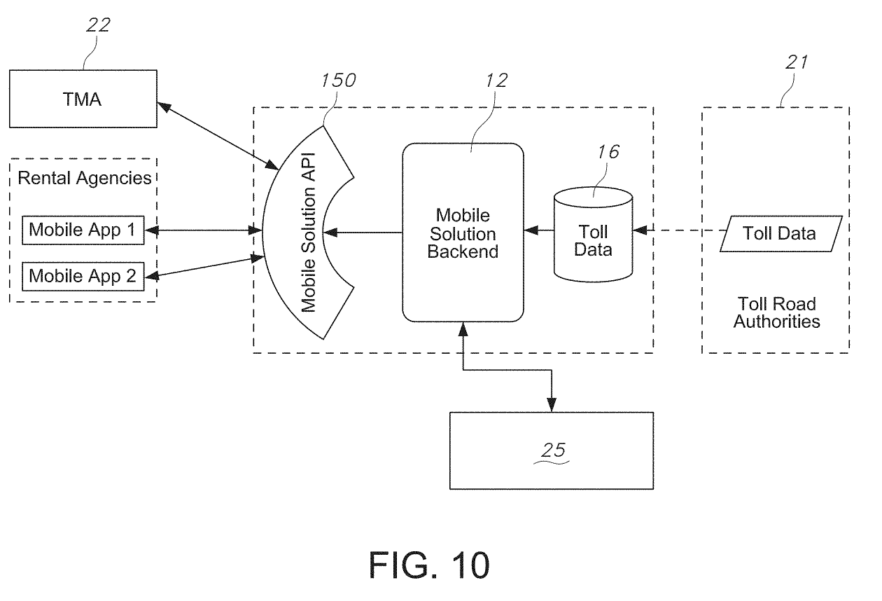

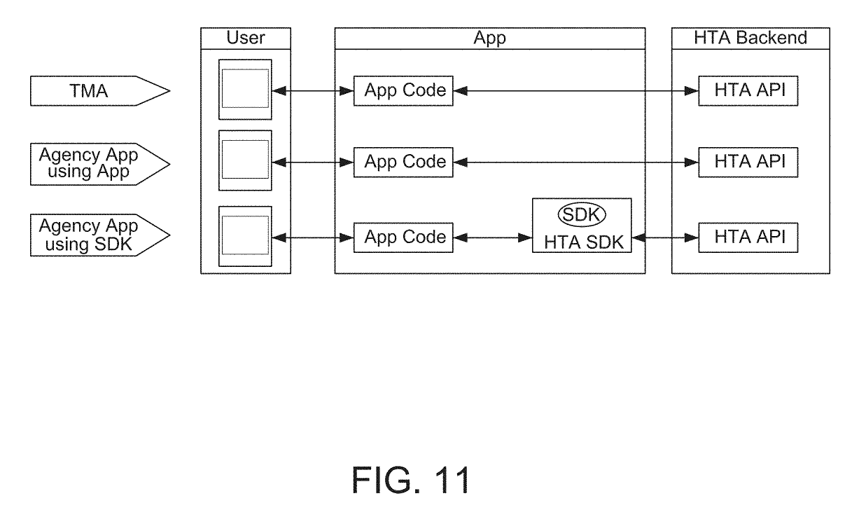

The TMA may exist as a separate application or may be embedded within existing mobile applications using an application. For example, the functionalities of the TMA may be integrated with a rental car agency's mobile application. The application may include a user input choice to select the toll management functionality. The mobile software may then communicate with the toll management application programming interface (“API”) 150 as shown in FIG. 9. Alternatively, the toll management server may interface via the API with the TMA as well as the applications of various rental agencies. FIG. 10. The API 150 communicates with the toll management system server 12. The server may communicate with the toll authority and output toll information to external expense system. Accordingly, the API exposes the various functionalities of the platform as a Web Service API, and functionality can be embedded within existing third party mobile applications via the API. See FIGS. 10 and 11.

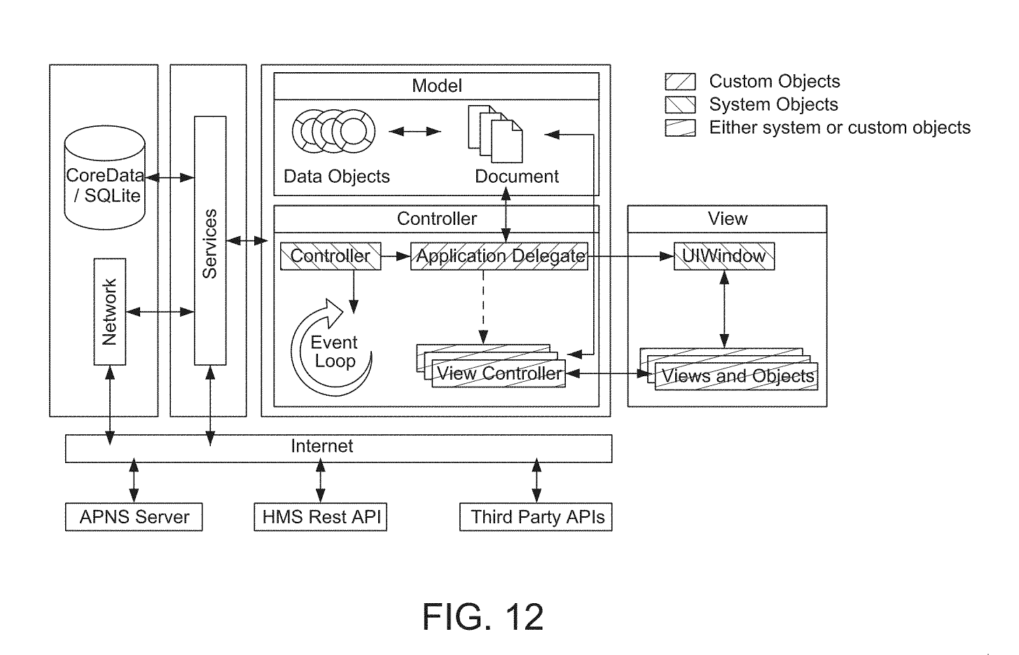

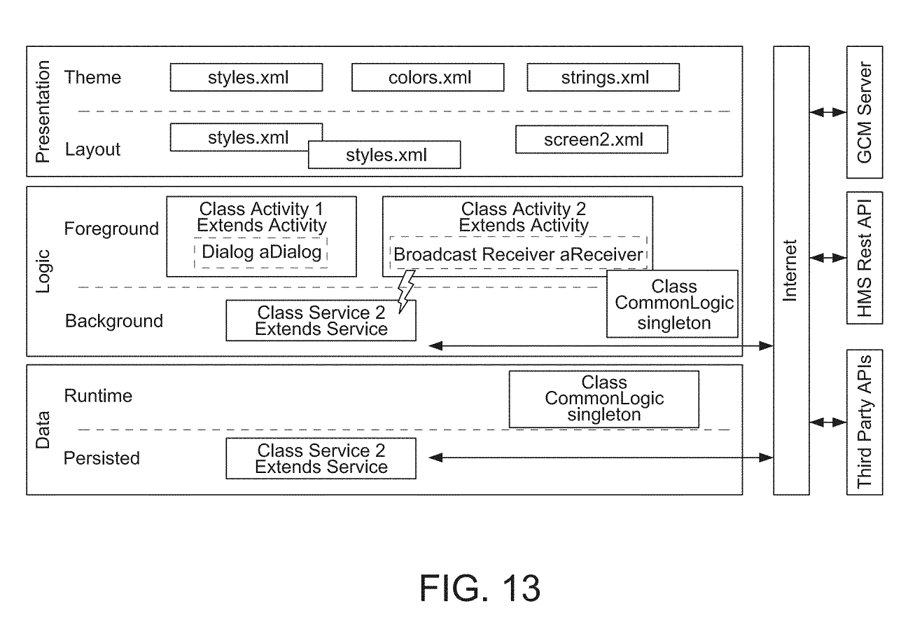

It is further contemplated that the TMA may be designed to run with various operating systems such as Android, iOS, and JS. A plurality of software development kits may be provided that target particular mobile scripting languages that will assist developers with getting started and integrating the TMA API. See FIGS. 12 and 13.

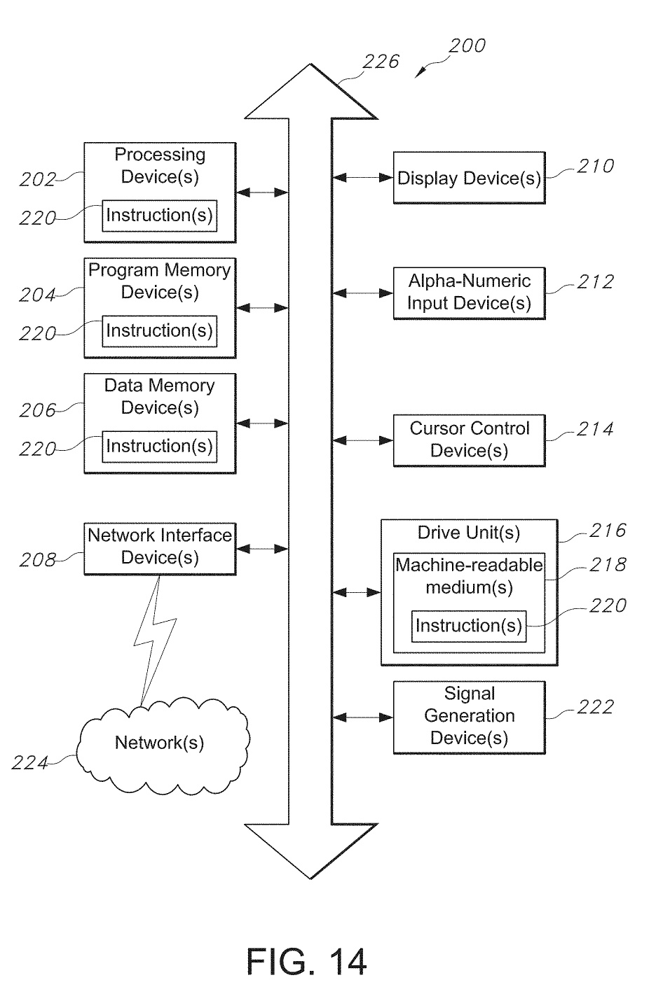

As illustrated in FIG. 14, the toll management server 12 may include a computer system 200 may include a processor 202, e.g., a central processing module (CPU), a graphics-processing module (GPU), or both. Moreover, the computer system 200 may include a main memory 204 and a static memory 206 that can communicate with each other via a bus 226. As shown, the computer system 200 may further include a video display device 210, such as a liquid crystal display (LCD), an organic light emitting diode (OLED), a flat panel display, a solid state display, or a cathode ray tube (CRT). Additionally, the computer system 200 may include an input device 212, such as a keyboard, and a cursor control device 214, such as a mouse. The computer system 200 can also include a disk drive device 216, a signal generation device 222, such as a speaker or remote control, and a network interface device 208.

In a particular embodiment or aspect, as depicted in FIG. 14, the disk drive device 216 may include a computer-readable medium 218 in which one or more sets of instructions 220, e.g., software, can be embedded. Further, the instructions 220 may embody one or more of the methods or logic as described herein. In a particular embodiment or aspect, the instructions 220 may reside completely, or at least partially, within the main memory 204, the static memory 206, and/or within the processing device 202 during execution by the computer system 200. The main memory 204 and the processing device 202 also may include computer-readable media.

In an alternative embodiment or aspect, dedicated hardware implementations, such as application specific integrated circuits, programmable logic arrays and other hardware devices, can be constructed to implement one or more of the methods described herein. Applications that may include the apparatus and systems of various embodiments or aspects can broadly include a variety of electronic and computer systems. One or more embodiments or aspects described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments or aspects, the methods described herein may be implemented by software programs tangibly embodied in a processor-readable medium and may be executed by a processing device. Further, in an exemplary, non-limited embodiment or aspect, implementations can include distributed processing, component/object distributed processing, and parallel processing. Alternatively, virtual computer system processing can be constructed to implement one or more of the methods or functionality as described herein.

It is also contemplated that a computer-readable medium includes instructions 220 or receives and executes instructions 220 responsive to a propagated signal, so that a device connected to a network 224 can communicate voice, video or data over the network 224. Further, the instructions 220 may be transmitted or received over the network 224 via the network interface device 208.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processing device or that cause a computer system to perform any one or more of the methods or operations disclosed herein.

In a particular non-limiting example, embodiment or aspect, the computer-readable medium can include a solid-state memory, such as a memory card or other package, which houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals, such as a signal communicated over a transmission medium. A digital file attachment to an e-mail or other self-contained information archive or set of archives may be considered a distribution medium that is equivalent to a tangible storage medium. Accordingly, any one or more of a computer-readable medium or a distribution medium and other equivalents and successor media, in which data or instructions may be stored, are included herein.

In accordance with various embodiments or aspects, the methods described herein may be implemented as one or more software programs running on a computer processing device. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, a tangible storage medium or distribution medium as listed herein, and other equivalents and successor media, in which the software implementations herein may be stored, are included herein.

Although the present specification describes components and functions implemented in the embodiments with reference to particular standards and protocols, the disclosed embodiment is not limited to such standards and protocols.

In accordance with various embodiments, the methods, functions or logic described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods, functions or logic described herein.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

Although preferred embodiments have been described herein with reference to the accompanying drawings, it is to be understood that the disclosure is not limited to those precise embodiments and that various other changes and modifications may be affected herein by one skilled in the art without departing from the scope or spirit of the embodiments, and that it is intended to claim all such changes and modifications that fall within the scope of this disclosure.

What is claimed is:

1. A system for acquiring and communicating toll data comprising:
a server including a processing device and memory device operably connected to a toll database including toll related data related to toll usage;
the server retrieving toll related data from the toll database at predetermined time intervals, the toll related data being acquired by a toll interrogation device from a toll identification device disposed on, and unique to, a particular vehicle passing though a tolling station; and
the processing device matching the retrieved toll data to a toll user responsible for the toll usage, the server electronically transmitting the matched toll information to the toll user.

2. The system as defined in claim 1, wherein the toll identification device is an RFID transponder.

3. The system as defined in claim 1, wherein the toll identification device is interrogated by a scanner and/or an optical camera.

4. The system as defined in claim 1, further including a software application running on a mobile computing device, the server being in wireless communication with the software application, the server communicating the matched toll information to the software application running on the user's mobile device.

5. The system as defined in claim 1, wherein the matched toll data includes toll monetary charges.

6. The system as defined in claim 1, wherein in response to an input by the user on the mobile application, the server transmits the toll monetary charges to a third party to facilitate reimbursement of the charges for the user.

7. The system as defined in claim 1, wherein the server communicates with a toll authority maintaining the toll database in order to retrieve the toll data.

8. The system as defined in claim 7, wherein the total data includes identification information and toll amount information.

9. The system as defined in claim 1, wherein matching includes reviewing the toll data for duplicate data.

10. The system as defined in claim 9, wherein matching includes moving unique toll data to memory, and matching identification information to a vehicle owner.

11. The system as defined in claim 10, wherein the vehicle owner is a vehicle rental agency.

12. The system as defined in claim 11, wherein the toll identification device is adapted to be interrogated by a scanning device disposed at a toll location.

13. A system for acquiring and communicating toll data comprising:
a toll management system including a server, the server including:
a memory device having instructions stored thereon; and
a processing device operably coupled to the memory device, wherein the processing device, upon execution of the instructions, performs steps comprising:
receiving registration information from a user wherein a vehicle identification device disposed on a vehicle is linked to a user;
receiving toll data including toll activity from the toll database;
matching the received toll data to a toll user responsible for the toll usage;
transmitting the matched toll data to a software application on a user's mobile device; and
receiving an instruction from the user's mobile device to transmit the toll data to a third party, and transmitting the toll data responsive to the instruction.

14. The system as defined in claim 13, wherein matching the retrieved toll data includes creating a temporary table and moving the toll information to the temporary table; initiating a check for duplicate tolls; moving duplicates to duplicate table; non duplicates are moved to a toll activity repository; and identifying the owner of the toll charges and transmitting the toll data to the owner.

15. The system as defined in claim 13, wherein the server pulls the data from the toll database at predetermined intervals.

16. The system as defined in claim 13, wherein the toll data is received by the server as the toll activity is incurred in real time.

17. A method for acquiring and communicating toll data comprising:
providing an input for setting up a user account on a mobile computing device;
inputting identifying information;
wirelessly communicating with a server, the server including a processing device and being in operative communication with a toll database; the server periodically communicating with the toll database to obtain toll data at predetermined times;
receiving from the server toll data specific to the user account;
displaying the toll data on a display;
providing a selection for the user to initiate transmittal of the toll charges to a third party reimbursement server; and
the server transmitting the user information and the toll charges to the third party expense management system.

18. The method as defined in claim 17, wherein the identifying information is vehicle identification data.

19. A method for acquiring and communicating toll data comprising:
receiving registration information from a user wherein a vehicle identification device disposed on a vehicle is linked to a user;
receiving toll data including toll activity from the toll database;
matching the received toll data to a toll user responsible for the toll usage;
transmitting the matched toll data to a mobile device; and
receiving an instruction from the mobile device to transmit the toll data to a third party, and transmitting the toll data responsive to the instruction.

20. The method as defined in claim 19, wherein matching includes:
importing tolls from one or more toll accounts;
inserting the toll data into temporary table;
checking for duplicate tolls in the temporary table or in a database of a toll management system for criteria including at least on of toll entry time, toll exit time, toll entry plaza, toll exit plaza, license plate state, license plate number, and toll amount;
identifying duplicate tolls and insert into duplicates toll table; and
identify unique tolls and inserting into the database of the toll management system.

21. The method as defined in claim 20, wherein matching further includes:
inserting vehicle fleet information (open/closed rental agreement number, license plate number, plate state) sent by rental agency into toll management system;
if a license plate state & license plate number of the tolls from toll table matches with license plate state & license plate number sent by rental agency and the toll import date is less than ‘n’ number of days from current date then find the rental contract associated to the toll and bill one or a customer, a rental agency, or a private car user.

22. A non-transitory computer-readable storage medium including instructions that, when executed by a processing device, cause the processing device to process toll transactions by performing a computer process comprising:
receiving registration information from a user wherein a vehicle identification device is linked to a user;
receiving toll data from a toll database;
matching the received toll data to a toll user responsible for the toll usage;
transmitting the matched toll data to a mobile device;
receiving an instruction from the mobile device to transmit the toll data to a third party; and
transmitting the toll data responsive to the instruction.

23. The non-transitory computer-readable storage medium as defined in claim 22, including initiating communication with the toll database to receive the toll data at predetermined intervals.

24. The non-transitory computer-readable storage medium as defined in claim 22, including receiving toll data from the toll database in real time as the toll charges are incurred.
